(19) United States
(12) Patent Application Publication
(10) Pub. No.: US 2015/0331832 A1
(43) Pub. Date: Nov. 19, 2015

(54) ARITHMETIC PROCESSING APPARATUS

(71) Applicant: Denso Corporation, Kariya-city (JP)

(72) Inventors: Kenichi MINOYA, Kariya-city (JP); Tomoaki OZAKI, Anjo-city (JP)

(21) Appl. No.: 14/672,434

(22) Filed: Mar. 30, 2015

(30) Foreign Application Priority Data
May 13, 2014 (JP) 2014-99569

(51) Int. Cl. G06F 17/10; G06N 3/04

(52) U.S. Cl. CPC G06F 17/10; G06N 3/04

(57) ABSTRACT

An arithmetic processing apparatus executing arithmetic by a neural network in which multiple processing layers are hierarchically connected is provided. The arithmetic processing apparatus includes multiple arithmetic blocks corresponding to one of the multiple processing layers. Each of the arithmetic blocks includes a convolution arithmetic portion, an activation portion, a pooling portion, and a normalization portion. The convolution arithmetic portion executes convolution arithmetic processing. The normalization portion executes normalization to a processing result data generated by the pooling portion. The normalization portion includes a first output portion, a second output portion, and a normalization execution portion. The first output portion outputs a first data. The second output portion outputs an addition data as a second data. The normalization execution portion executes normalization to the first data based on the second data.

### CROSS REFERENCE TO RELATED APPLICATION

This application is based on Japanese Patent Application No. 2014-99569 filed on May 13, 2014, the disclosure of which is incorporated herein by reference.

### TECHNICAL FIELD

The present disclosure relates to an arithmetic processing apparatus.

### BACKGROUND ART

Patent literature 1: Japanese Patent No. 5184824

Conventionally, an arithmetic processing apparatus performs arithmetic by a neural network in which multiple processing layers are hierarchically connected. Especially, an arithmetic processing apparatus performing image recognition uses a so-called convolutional neural network as a core technology.

A conventional convolutional neural network executes convolution arithmetic processing to different multiple arithmetic result data obtained in a precedent layer. That is, a conventional convolutional neural network executes convolution arithmetic processing to an extraction result data of a feature quantity. A conventional convolutional neural network executes activation processing, executes pooling processing, and extracts feature quantity in a higher dimension.

The inventors of the present application have found the following. When normalization processing may be performed to a processing result data by the pooling processing, a recognition rate of feature quantity may be improved and extraction processing of feature quantity may be performed better.

### SUMMARY

It is an object of the present disclosure to provide an arithmetic processing apparatus realizing arithmetic processing by a neural network. The arithmetic processing apparatus in the present disclosure is enhanced in a configuration for performing normalization processing and enables to perform feature quantity extraction processing better than a conventional arithmetic processing apparatus.

According to one aspect of the present disclosure, an arithmetic processing apparatus executing arithmetic by a neural network in which multiple processing layers are hierarchically connected is provided. The arithmetic processing apparatus includes multiple arithmetic blocks corresponding to one of the multiple processing layers.

Each of the multiple arithmetic blocks includes: a convolution arithmetic portion executing convolution arithmetic processing to an input data that is input from another of the multiple of processing layers; an activation portion executing activation processing to a processing result data generated by the convolution arithmetic portion; a pooling portion executing pooling processing to a processing result data generated by the activation portion; and a normalization portion executing normalization to a processing result data generated by the pooling portion. The normalization portion includes a first output portion, a second output portion, and a normalization execution portion. The first output portion outputs the processing result data generated by the pooling portion as a first data. The normalization portion is included in a certain arithmetic block same as the pooling portion. The second output portion outputs an addition data as a second data. The addition data is obtained by adding the first data and a processing result data generated by a pooling portion in a different arithmetic block, which is different from the certain arithmetic block generating the first data. The normalization execution portion executes normalization to the first data based on the second data.

According to the arithmetic processing apparatus, it may be possible to normalize the processing result data generated by the pooling portion in the arithmetic block using the processing result data generated by the pooling portion in a different arithmetic block. It may be possible to precisely normalize the processing result data generated by the pooling processing, and to realize a more superior feature extraction processing. The normalization portion includes the first output portion, the second output portion, and the normalization execution portion. Therefore, it may be possible to realize the normalization portion without making a complex circuit configuration.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram schematically illustrating a configuration example of a convolutional neural network;

FIG. 2 is a diagram visually illustrating a flow of arithmetic processing by an arithmetic processing apparatus;

FIG. 3 is a diagram illustrating general arithmetic and functions used in feature quantity extraction processing;

FIG. 4 is a block diagram schematically illustrating a configuration example of an arithmetic processing apparatus in a first embodiment;

FIG. 5 is a diagram illustrating an example of a normalization function;

FIG. 6 is a diagram visually illustrating an obtaining of a normalized data through normalization of a pooling data;

FIG. 7 is a diagram visually illustrating an execution of normalization processing in parallel;

FIG. 8 is a diagram illustrating pipeline processing by the arithmetic processing apparatus;

FIG. 9 is a block diagram schematically illustrating a configuration example of an arithmetic processing apparatus in a second embodiment;

FIG. 10 is a diagram illustrating an example of a normalization function;

FIG. 11 is a diagram illustrating pipeline processing by the arithmetic processing apparatus; and

FIG. 12 is a block diagram schematically illustrating a configuration example of an arithmetic processing apparatus in a third embodiment.

### DETAILED DESCRIPTION

In the following, multiple embodiments of an arithmetic processing apparatus will be explained with referring to the drawings. Incidentally, the identical symbol will be given to substantially identical elements in each embodiment and explanation will be omitted.

(Neural Network)

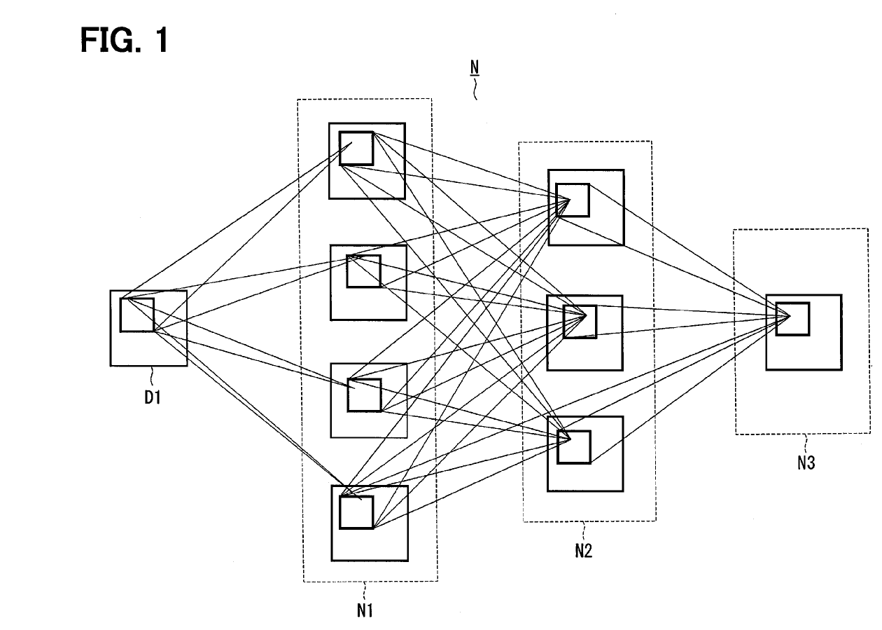

FIG. 1 schematically illustrates a configuration of a neural network that is applied to arithmetic processing apparatus 100, 200, 300. The neural network corresponds to a convolutional neural network in this case. In a convolutional neural network N, multiple feature quantity extraction processing layers N1, N2, N3 are hierarchically connected. The convolutional neural network N is applied to an image recognition technology in which a predetermined shape or a predetermined pattern is recognized from an image data D1, which is an input data. In the feature quantity extraction processing layer N1 corresponding to the first layer, the arithmetic processing apparatus scans the image data D1, which is input, for each predetermined size by a raster scan, for example. The feature quantity extraction processing layer N1 extracts feature quantity by performing feature quantity extraction processing to the scanned data. The feature quantity extraction processing layer N1 corresponding to the first layer extracts a relatively simple and single feature such as a linear feature quantity extending toward a horizontal direction, a linear feature quantity extending toward an oblique direction, or the like.

In the feature quantity extraction processing layer N2 corresponding to the second layer, the arithmetic processing apparatus scans an input data, which is input from the feature quantity extraction processing layer N1 of the preceding layer, for each predetermined size by the raster scan, for example. The feature quantity extraction processing layer N2 extracts feature quantity by performing feature quantity extraction processing to the scanned data. The feature quantity extraction processing layer N2 of the second layer integrates multiple feature quantity extracted in the feature quantity extraction processing layer N1 of the first layer by considering a spatial relationship of the multiple feature quantity, so that a compositive feature quantity is extracted with a higher dimension.

In the feature quantity extraction processing layer N3 of the third layer, the arithmetic processing apparatus scans an input data, which is input from the feature quantity extraction processing layer N2 of the preceding layer, for each predetermined size by the raster scan, for example. The feature quantity extraction processing layer N3 extracts feature quantity by performing feature quantity extraction processing to the scanned data. The feature quantity extraction processing layer N3 of the third layer integrates multiple feature quantity extracted in the feature quantity extraction processing layer N2 of the second layer by considering a spatial relationship of the multiple feature quantity, so that a compositive feature quantity is extracted with a higher dimension. Therefore, by repeating feature extraction processing in multiple feature quantity processing layers, the arithmetic processing apparatus performs image recognition of a detection object included in the image data D1.

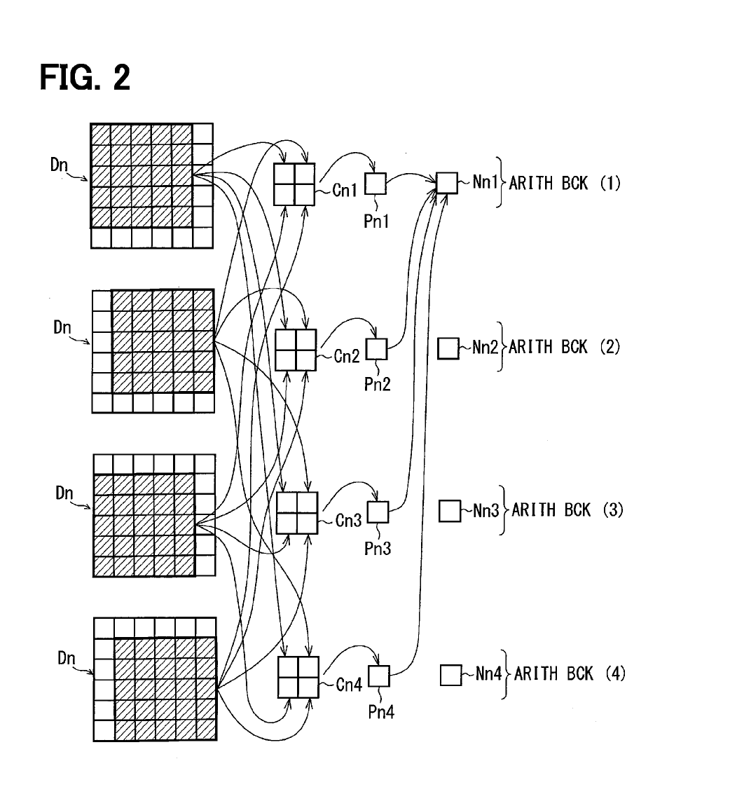

FIG. 2 visually illustrates a flow of operation processing by the operation processing apparatus. That is, the arithmetic processing apparatus scans an input data Dn, which is input from a feature quantity extraction processing layer of a preceding layer, for a predetermined size. In a case of FIG. 2, the predetermined size corresponds to a 5×5 pixels illustrated by hatching. The arithmetic processing apparatus performs convolution arithmetic to the scanned data. The arithmetic processing apparatus performs pooling processing to a data Cn1, Cn2, or the like after the convolution arithmetic for each predetermined size. In this case, the predetermined size corresponds to 2×2 pixels. The arithmetic processing apparatus outputs data Pn1, Pn2, or the like after the pooling processing to a feature quantity extraction processing layer of a next layer.

The arithmetic processing apparatus performs a well-known normalization processing to the data Pn1, Pn2, or the like after the pooling processing to convert the pooling data Pn to a normalized data Nn1 Nn2, or the like with a predetermined standard format, and then, outputs the normalized data Nn1, Nn2, or the like to a next layer. Accordingly, the arithmetic processing apparatus outputs the pooling data Pn to the next layer in a more unified format. Therefore, a recognition rate of feature quantity may be improved, and extraction processing of the feature quantity may be performed better. The arithmetic processing apparatus in the present embodiments may perform the normalization processing more effectively.

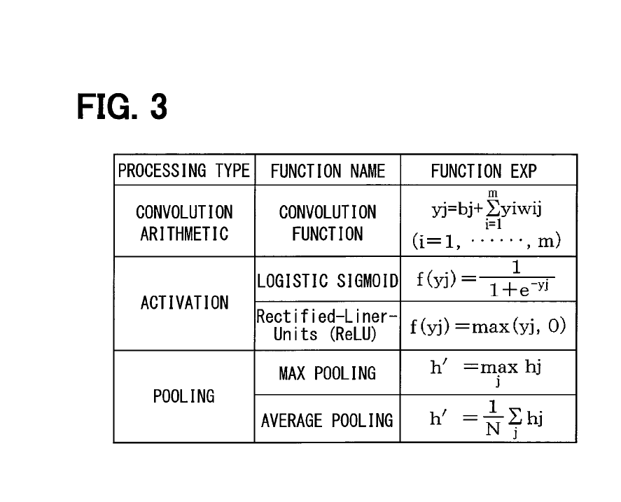

FIG. 3 illustrates a general example of a convolution function used in convolution arithmetic processing, a function used in activation processing, and a function used in pooling processing. The convolution function yj corresponds to a function adds a predetermined bias value Bj to a sum obtained by multiplying an output yi of an immediate preceding layer by a weight coefficient wij obtained by a learning. The activation processing uses a well-known logistic sigmoid function, a ReLu function (a rectified linear units function), or the like. In the activation processing, another kind of a nonlinear function may be used. The pooling processing uses a well-known maximum pooling function outputting a maximum value of an input data, an average pooling function outputting an average value of the input data, or the like.

### First Embodiment

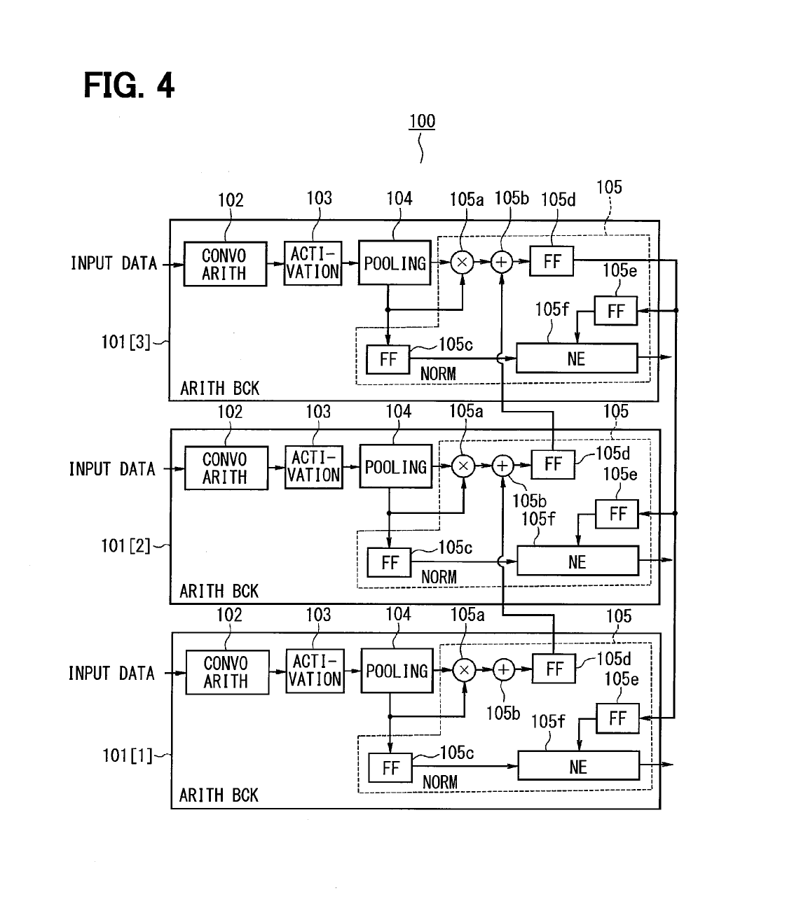

An arithmetic processing apparatus 100 in FIG. 4 includes multiple arithmetic blocks 101 (n). In the present embodiment, the arithmetic processing apparatus 100 includes three arithmetic blocks 101 (1), 101(2), 101(3) as an example. Incidentally, for convenience of explanation, the arithmetic block 101 (1) may be referred to as an initial arithmetic block, and the arithmetic block 101 (3) may be referred to as a last arithmetic block. The arithmetic block 101 (n) includes a convolution arithmetic portion 102, an activation portion 103, a pooling portion 104, and a normalization portion 105.

The convolution arithmetic portion 102 executes a well-known convolution arithmetic processing to the input data, which is input from a preceding layer. The convolution arithmetic portion 102 outputs a processing result data to the activation portion 103. The activation portion 103 executes a well-known activation processing to the processing result data generated by the convolution arithmetic portion 102. The activation portion 103 outputs the processing result data to the pooling portion 104. The pooling portion 104 executes a well-known pooling processing to the processing result data generated by the activation portion 103. The pooling portion 104 outputs the processing result data to the normalization portion 105. The processing result data generated by the pooling portion 104 may be referred to as a pooling data Pj.

The normalization portion 105 includes a multiplier 105a, an adder 105b, flip-flop circuits 105c, 105d, 105e, and a normalization execution portion 105f. The multiplier 105a squares the pooling data Pj generated by the pooling portion 104 in the arithmetic block 101 (n) including the multiplier 105a to obtain a value Pĵ2. The adder 105b in the initial arithmetic block 101 (1) has a function different from the adder 105b included in the arithmetic blocks 101(2), 101 (3). Incidentally, the value Pĵ2 means a square of Pj.

The adder 105b included in the initial arithmetic block 101 (1) just outputs the value Pĵ2, which is obtained from the multiplier 105a in the arithmetic block 101 (1) including the adder 105b, to the flip-flop circuit 105d. The adder 105b included in the arithmetic blocks 101 (2), 101 (3), which are other than the initial arithmetic block 101 (1), adds the value Pĵ2 obtained from the multiplier 105a of the arithmetic block 101 (n) including the adder 105b to a cumulative value obtained from the adder 105b in a different arithmetic block 101 (n) through the flip-flop circuit 105d to generate a new cumulative value.

The flip-flop circuit 105c corresponds to an example of a first output portion. The flip-flop circuit 105c stores a pooling data Pj generated by the pooling portion 104 in the arithmetic block 101 (n) including the flip-flop circuit 105c. The pooling data Pj corresponds to a first data. The normalization execution portion 105f in the arithmetic block 101 (n) including to the flip-flop circuit 105c receives the pooling data Pj stored in the flip-flop circuit 105c. The flip-flop circuit 105c may be multiple flip-flop circuits.

The flip-flop circuit 105d in the last arithmetic block 101 (3) has a function different from the flip-flop circuit 105d in the other arithmetic blocks 101 (1), 101 (2). The flip-flop circuit 105d in the arithmetic blocks 101 (1), 101 (2), which are other than the last arithmetic 101 (3), stores a cumulative value obtained from the adder 105b in the arithmetic blocks 101 (1), 101 (2) including the flip-flop circuit 105d. The adder 105b in the arithmetic blocks 101 (2), 101 (3) immediately nearly provided to a side of the last arithmetic block 101 (3) receives the cumulative value stored in the flip-flop circuit 105d.

The flip-flop circuit 105d in the last arithmetic block 101 (3) stores the cumulative value obtained from the adder 105b in the last arithmetic block 101 (3). The flip-flop circuit 105d in the last arithmetic block 101 (3) stores an addition data S. The addition data S corresponds to a sum of the square values Pĵ2 of the pooling data Pj generated by all of the pooling portions 104 in multiple arithmetic blocks 101 (1) to 101 (3). Incidentally, the multiple arithmetic blocks 101 (1) to 101 (3) include the last arithmetic block 101 (3). The flip-flop circuit 105d in the last arithmetic block 101 (3) stores the addition data S. The flip-flop circuit 105e in each of the arithmetic blocks 101 (1) to 101 (3) receives the stored addition data S.

Incidentally, each of the arithmetic blocks 101 (1) to 101 (3) may correspond to a subject arithmetic block, and the flip-flop circuit 105e in each of the arithmetic blocks 101 (1) to 101 (3) may correspond to a subject second output portion in the present disclosure.

The flip-flop circuit 105e corresponds to an example of a second output portion. The flip-flop circuit 105e stores the addition data S, which is obtained from the flip-flop circuit 105d in the last arithmetic block 101 (3). The flip-flop circuit 105e outputs the stored addition data S to the normalization execution portion 105f in the arithmetic blocks 101 (1) to 101 (3) corresponding to the flip-flop circuit 105e. Accordingly, the normalization execution portion 105f in all of the arithmetic blocks 101 (1) to 101 (3) receives the addition data S obtained from the last arithmetic block 101 (3). The addition data S corresponds to a second data.

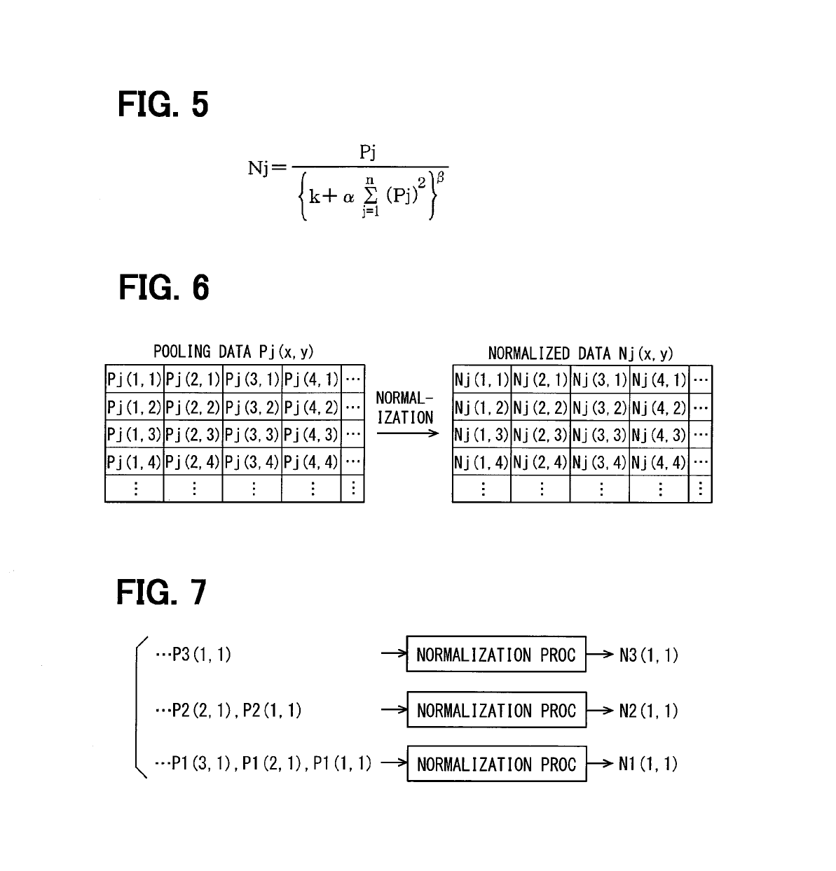

The normalization execution portion 105f executes normalization processing to the pooling data Pj, which is obtained from the flip-flop circuit 105c in the arithmetic block 101 (n) including the normalization execution portion 105f, based on the addition data S. In this case, the normalization execution portion 105f executes the normalization processing according to the function described in FIG. 5, for example. Incidentally, values of constants k, alpha, beta may be set appropriately by changing.

In FIG. 5, the symbol of Nj corresponds to a normalized data generated by an arithmetic block 101 (j). The symbol of Pj corresponds to a pooling data generated by an arithmetic block 101 (j). The symbol of n represents a total number of arithmetic blocks 101 (j).

As described in FIG. 6, each of the arithmetic blocks 101 (1) to 101 (3) in the arithmetic processing apparatus 100 performs the normalization processing by the normalization portion 105 to a pooling data Pj (x,y) obtained from each of the pooling portion 104. Accordingly, each of the arithmetic blocks 101 (1) to 101 (3) generates a processing result data Nj (x,y), which is normalized, and outputs the processing result data Nj (x,y) to a next layer. As described in FIG. 7, in the present embodiment, the arithmetic blocks 101 (1) to 101 (3) execute the normalization processing to the pooling data Pj (x,y) in parallel. Incidentally, for convenience of explanation, the pooling data Pj (x,y) input to the normalization portion 105 in the arithmetic block 101 (1) may be referred to as a P1 (x,y). The pooling data Pj (x,y) input to the normalization portion 105 in the arithmetic block 101 (2) may be referred to as a P2 (x,y). The pooling data Pj (x,y) input to the normalization portion 105 in the arithmetic block 101 (3) may be referred to as a P3 (x,y).

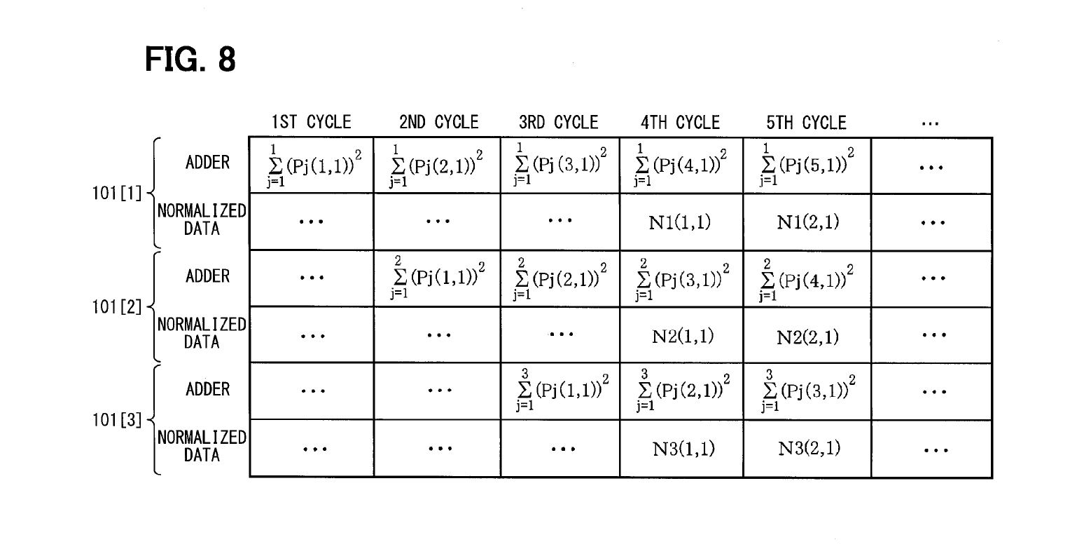

As described in FIG. 8, according to the first arithmetic cycle by the arithmetic processing apparatus 100, the adder 105b in the initial arithmetic block 101 (1) stores a square value P1 (1,1)̂2, which is obtained by squaring the pooling data P1 (1,1) generated by the pooling portion 104 in the arithmetic block 101 (1) including the adder 105b. In other words, the pooling portion 104 in the arithmetic block 101 (1) generates the pooling data P1 (1,1). The adder 105b in the arithmetic block 101 (1) stores the value P1 (1,1)̂2, which corresponds to a square of the pooling data P1 (1,1). Incidentally, the adder 105b in the initial arithmetic block 101 (1) does not receive a cumulative value from the other arithmetic blocks 101 (2), 101 (3). The adder 105b in the initial arithmetic block 101 (1) just receives the value P1 (1,1)̂2, which is obtained by squaring the pooling data P1 (1,1) generated by the pooling portion 104 in the initial arithmetic block 101 (1).

In the second arithmetic cycle by the arithmetic processing apparatus 100, the adder 105b in the initial arithmetic block 101 (1) stores a square value P1 (2,1)̂2, which is obtained by squaring the pooling data P1 (2,1) generated by the pooling portion 104 in the initial arithmetic block 101 (1). The adder 105b in the arithmetic block 101 (2) (hereinafter, also referred to as an intermediate arithmetic block 101 (2)) stores a value obtained by adding the value P1 (1,1)̂2, which is obtained from the initial arithmetic block 101 (1), and a value P2 (1,1)̂2, which is obtained by squaring a pooling data P2 (1,1) generated by the pooling portion 104 in the arithmetic block 101 (2).

In the third arithmetic cycle by the arithmetic processing apparatus 100, the adder 105b in the initial arithmetic block 101 (1) stores a value P1 (3,1)̂2, which is obtained by squaring the pooling data P1 (3,1) generated by the pooling portion 104 in the initial arithmetic block 101 (1). The adder 105b in the intermediate arithmetic block 101 (2) stores a value obtained by adding the value P1 (2,1)̂2, which is obtained from the initial arithmetic block 101 (1), and a value P2 (2,1)̂2, which is obtained by squaring a pooling data P2 (2,1) generated by the pooling portion 104 in the intermediate arithmetic block 101 (2). The adder 105b in the last arithmetic block 101 (3) stores a value obtained by adding the value P1 (1,1)̂2 obtained from the initial arithmetic block 101 (1), the value P2 (1,1)̂2 obtained from the intermediate arithmetic block 101 (2), and a value P3 (1,1)̂2 obtained by squaring the pooling data P3 (1,1) generated by the pooling portion 104 in the last arithmetic block 101 (3).

Accordingly, the adder 105b in the last arithmetic block 101 (3) obtains a cumulative value that is obtained by accumulating square values Pj (1,1)̂2 of the pooling data Pj (1,1) generated by each of the pooling portion 104 in all of the arithmetic blocks 101 (1) to 101 (3). The cumulative value corresponds to the addition data S. In the fourth arithmetic cycle, all of the normalization execution portions 105f included in all of the arithmetic blocks 101 (1) to 101 (3) execute the normalization processing to the pooling data Pj based on the addition data S, which is obtained from the adder 105b in the last arithmetic block 101 (3). Accordingly, the normalized processing data Nj (1,1) corresponding to the processing result data Pj (1,1) of the pooling processing is obtained.

According to the arithmetic processing apparatus 100, it may be possible to normalize the pooling data Pj generated by the pooling portion 104 in the arithmetic block 101 (n) using the pooling data Pj generated by the pooling portion 104 in a different arithmetic block 101 (n). It may be possible to precisely normalize the pooling data Pj of the pooling processing, and to realize a more superior feature extraction processing.

The normalization portion 105 includes the flip-flop circuit 105c functioning as the first output portion, the flip-flop circuit 105e functioning as the second output portion, the normalization execution portion 105f that normalizes the pooling data Pj obtained from the first output portion based on the addition data S obtained from the second output portion. Therefore, it may be possible to realize the normalization portion 105 and the arithmetic processing apparatus 100 without making a complex circuit configuration.

According to the arithmetic processing apparatus 100, the flip-flop circuit 105e functioning as the second output portion outputs the addition data S that is obtained by adding the square value of the pooling data Pj generated by all of the pooling portions 104 in the multiple arithmetic block 101 (1) to 101 (3). The addition data S corresponds to the second data. The multiple arithmetic blocks 101 (1) to 101 (3) includes an arithmetic block including the flip-flop circuit 105e. According to the second output portion, it may be possible to realize the normalization portion 105 and the arithmetic processing apparatus 100 with a more simple circuit configuration.

It should be noted that the number of the arithmetic blocks 101 (n) in the arithmetic processing apparatus 100 is not limited to three, and the number of the arithmetic blocks 101 (n) may be determined appropriately by changing.

### Second Embodiment

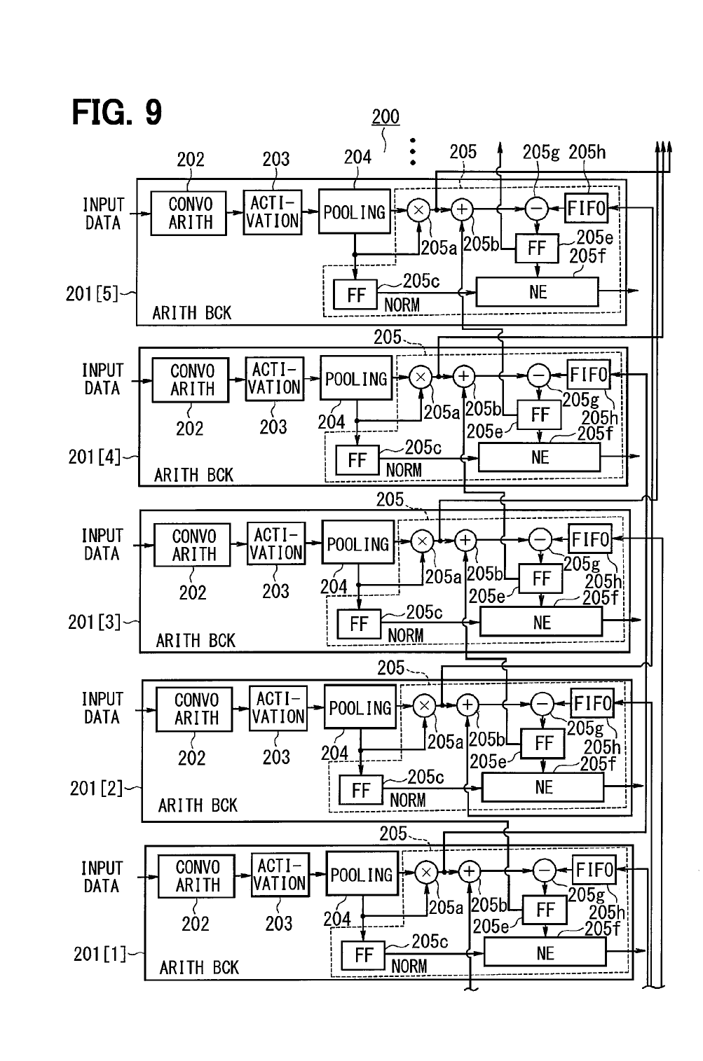

An arithmetic processing apparatus 200 in FIG. 9 includes multiple arithmetic blocks 201 (n). In this embodiment, as an example, the arithmetic processing apparatus 200 includes at least five arithmetic blocks 201 (1), 201 (2), 201 (3), 201 (4), 201 (5). Incidentally, for convenience of explanation, an arithmetic block 201 (n) positioned to an upper side in FIG. 9 in an upright position may be referred to as a higher arithmetic block, and an arithmetic block 201 (n) positioned to a lower side in an upright position may be referred to as a lower arithmetic block. An arithmetic block 201 (n) includes a convolution arithmetic portion 202, an activation portion 203, a pooling portion 204, and a normalization portion 205. The convolution arithmetic portion 202, the activation portion 203, and the pooling portion 204 respectively have the configuration similar to the convolution arithmetic portion 102, the activation portion 103, and the pooling portion 104 in the first embodiment.

The normalization portion 205 includes a multiplier 205a, an adder 205b, flip-flop circuits 205c, 205e, a normalization execution portion 205f, a subtractor 205g, and a FIFO memory 205h. The multiplier 205a generates a value Pĵ2 obtained by squaring a pooling data Pj generated by the pooling portion 204 in the arithmetic block 201 (n) having the multiplier 205a. The adder 205b adds the value Pĵ2 obtained from the multiplier 205a in the arithmetic block 201 (n) including the adder 205b and a cumulative value obtained from the lower arithmetic block 201 (n) of the arithmetic block 201 (n) including the adder 205b. The adder 205b obtains a new cumulative value. Incidentally, the adder 205b in the lowest arithmetic block 201 (1) adds a value Pĵ2 obtained from the multiplier 205a in the lowest arithmetic block 201 (1) and a cumulative value obtained from the highest arithmetic block 201 (n), and generates a new cumulative value. That is, the multiple arithmetic blocks 201 (n) in the arithmetic processing apparatus 200 are connected in a loop shape.

The flip-flop circuit 205c corresponds to an example of the first output portion. The flip-flop circuit 205c stores the pooling data Pj generated by the pooling portion 204 in the arithmetic block 201 (n) including the flip-flop circuit 205c as the first data. The flip-flop circuit 205c storing the pooling data Pj outputs the pooling data Pj to the normalization execution portion 205f in the arithmetic block 201 (n) including the flip-flop circuit 205c. The flip-flop circuit 205c and the normalization execution portion 205f are included in the same arithmetic block 201 (n). The flip-flop circuit 205c may include multiple flip-flop circuits.

The FIFO memory 205h corresponds to a first-in first-out type memory. The FIFO memory 205h stores multiple values Pĵ2, which are sequentially obtained from the multiplier 205a in a different arithmetic block 201 (n). The different arithmetic block 201 (n) means the arithmetic block 201 (n) different from the arithmetic block 201 (n) having the FIFO memory 205h. The different arithmetic block 201 (n) includes a FIFO memory 205h. In this case, the arithmetic block 201 (4) sequentially stores the value Pĵ2, which is obtained from the arithmetic block 201 (1) in each arithmetic cycle. The arithmetic block 201 (5) sequentially stores the value Pĵ2, which is obtained from the arithmetic block 201 (2) in each arithmetic cycle. Therefore, the FIFO memory 205h in the arithmetic block 201 (n) sequentially obtains and stores a value Pĵ2 that is obtained from the multiplier 205a in an arithmetic block 201 (n−3), which is separated toward the lower side from the arithmetic block 201 (n) by three arithmetic blocks.

Incidentally, with respect to the lower side arithmetic blocks 201 (1) to 201 (3), it is supposed that the highest arithmetic block 201 (n) is positioned to the lower side of the lowest arithmetic block 201 (1). That is, the FIFO memory 205h in the arithmetic block 201 (3) receives the value Pĵ2 from the multiplier 205a in the highest arithmetic block 201 (n) (corresponding to the arithmetic block 201 (5) in FIG. 9). The FIFO memory 205h in the arithmetic block 201 (2) receives the Pĵ2 from the multiplier 205a in the second highest arithmetic block 201 (n−1) (corresponding to the arithmetic block 201 (4) in FIG. 9). The FIFO memory 205h in the arithmetic block 201 (1) receives the Pĵ2 from the multiplier 205a in the third highest arithmetic block 201 (n−2) (corresponding to the arithmetic block 201 (3) in FIG. 9).

The FIFO memory 205h in the arithmetic block 201 (n) outputs the value Pĵ2 that is stored in the most previously to the subtractor 205g in the arithmetic block 201 (n) having the FIFO memory 205h in each arithmetic cycle. The value Pĵ2 that is stored in the most previously may be referred to as a leading data.

The subtractor 205g subtracts the value Pĵ2, which is obtained from the FIFO memory 205h in the arithmetic block 201 (n) including the subtractor 205g, from the cumulative value obtained from the adder 205b in the arithmetic block 201 (n) including the subtractor 205g. The subtractor 205g outputs a subtraction data G, which is obtained by the subtraction, to the flip-flop circuit 105d. The subtraction data G corresponds to an example of the second data. The subtraction data G corresponds to an addition data obtained by adding a square value of the pooling data Pj by the pooling portion 204 in the arithmetic block 201 (n) including the subtractor 205g and a square value of the pooling data Pj generated by the pooling portion 204 in a predetermined number of the arithmetic blocks 201 (n−2), 201 (n−1), which are provided to the lower side of the arithmetic block 201 (n) including the subtractor 205g.

The flip-flop circuit 205e corresponds to an example of the second output portion. The flip-flop circuit 205e stores the subtraction data G, which is obtained from the subtractor 205g in the arithmetic block 201 (n) including the flip-flop circuit 205e. The flip-flop circuit 205e outputs the stored subtraction data G to the normalization execution portion 105f in the arithmetic block 101 (n) including the flip-flop circuit 205e. The flip-flop circuit 205e also outputs the stored subtraction data G to the adder 205b in the arithmetic block 201 (n+1), which is positioned in an immediate higher side of the arithmetic block 201 (n). Incidentally, the flip-flop circuit 205e in the highest arithmetic block 201 (n) outputs the stored subtraction data G to the adder 205b in the lowest arithmetic block 201 (1).

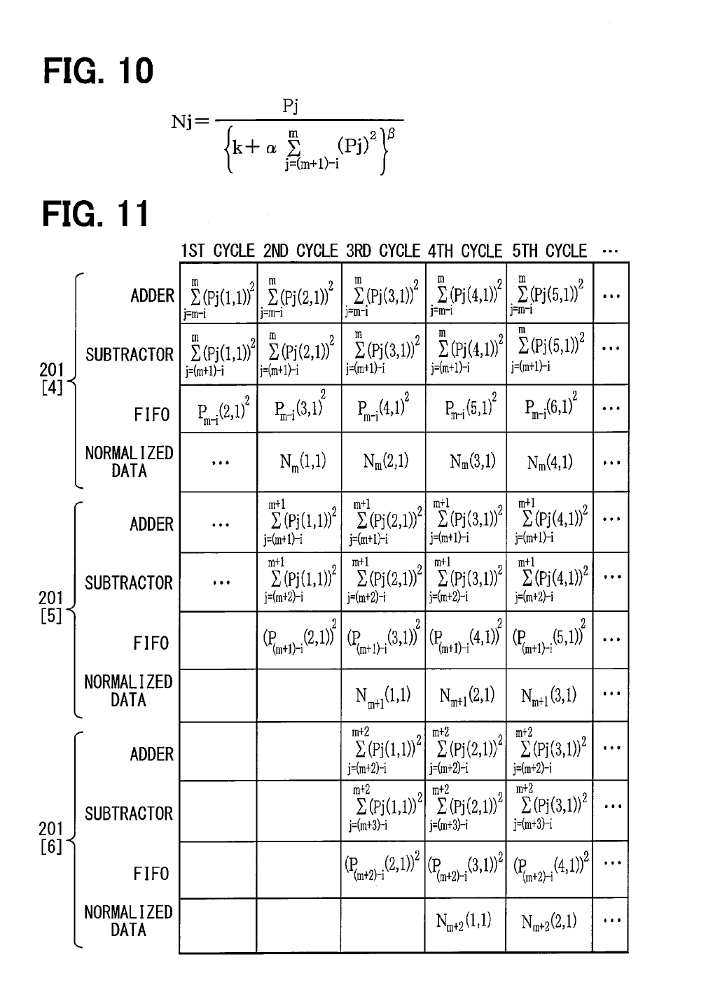

The normalization execution portion 205f executes the normalization processing to the pooling data Pj obtained from the flip-flop circuit 205c in the arithmetic block 201 (n) including the normalization execution portion 205f based on the subtraction data G. In this case, the normalization execution portion 205f executes the normalization processing with the function illustrated in FIG. 10, for example. Incidentally, values of constants k, alpha, beta may be determined appropriately by changing. A symbol of i represents the number of the normalization application arithmetic block. The arithmetic processing apparatus 200 sets up a normalization application arithmetic block when an arithmetic block 201 in the arithmetic processing apparatus 200 executes the normalization processing. The normalization application arithmetic block corresponds to i arithmetic blocks, which includes the arithmetic block 201 executing the normalization processing and a predetermined arithmetic block that is provided to the lower side vicinity of the arithmetic block. In FIG. 10, the symbol of Nj corresponds to a normalized data generated by the arithmetic block 101 (j), the symbol of Pj corresponds to a pooling data generated by the arithmetic block 101 (j), the symbol of m corresponds to the number of an arithmetic block, and the symbol of i corresponds to a total number of the normalization application arithmetic blocks.

That is, when i is set up to three, for example, with respect to the arithmetic block 201 (4), the normalization application arithmetic block includes the arithmetic block 201 (4), the arithmetic blocks 201 (3), 201 (2), which correspond to three arithmetic blocks. Incidentally, the arithmetic blocks 201 (3), 201 (2) are in the vicinity of the arithmetic block 201 (4). Accordingly, the normalization execution portion 205f in the arithmetic block 201 (4) receives the subtraction data G, that corresponds to a cumulative data obtained by accumulating the value P2 (x,y)̂2 obtained from the arithmetic block 201 (2), the value P2 (x,y)̂2 obtained from the arithmetic block 201 (3), and the value P4 (x,y)̂2 obtained from the arithmetic block 201 (4). That is, the number of the normalization application arithmetic blocks of the i is equal to a value representing the number of the value Pĵ2 configuring the subtraction data G. Incidentally, the arithmetic processing apparatus 200 may determine the i, which is representing the number of the normalization application arithmetic blocks appropriately by changing. Once the i is determined, the i may not be changed until a configuration is performed again. However, the arithmetic processing apparatus 200 may be configured to dynamically configure the i after the i is set up once.

As described in FIG. 11, each arithmetic block (n) in the arithmetic processing apparatus 200 executes the normalization processing in each normalization application arithmetic block in parallel. It is supposed that the number of the normalization processing application arithmetic block (corresponding to the i) is equal to three. In this case, the normalization processing by the arithmetic blocks 201 (4) to 201 (6) will be explained as an example. In the first arithmetic cycle by the arithmetic processing apparatus 200, the adder 205b in the arithmetic block 201 (4) stores a data obtained by accumulating a value P4 (1,1)̂2 that is obtained by squaring the pooling data P4 (1,1) generated by the pooling portion 104 in the arithmetic block 201 (4) including the adder 205b, the value P1 (1,1)̂2, the value P2 (1,1)̂2, and the value P3 (1,1)̂2, which are obtained from different arithmetic blocks 201 (1) to 201 (3). The adder 205b in the arithmetic block 201 (4) stores a cumulative value of the value P1 (1,1)̂2, the value P2 (1,1)̂2, the value P3 (1,1)̂2, and the value P4 (1,1)̂2.

The FIFO memory 205h in the arithmetic block 201 (4) stores the value P1 (1,1)̂2 obtained from the arithmetic block 201 (1). The subtractor 205g in the arithmetic block 201 (4) outputs a value obtained by subtracting the value P1 (1,1)̂2 stored in the FIFO memory 205h from the cumulative value of the value P1 (1,1)̂2, the value P2 (1,1)̂2, the value P3 (1,1)̂2, and the value P4 (1,1)̂2 stored in the adder 205b. That is, the subtractor 205g outputs the cumulative value of the value P2 (1,1)̂2, the value P3 (1,1)̂2, and the value P4 (1,1)̂2. Accordingly, the addition data obtained by adding the square value P4 (1,1)̂2 of the processing result data generated by the pooling portion 204 in the arithmetic block 201 (4) including the subtractor 205g, the square values P2 (1,1)̂2, P3 (1,1)̂2 of the processing result data generated by the pooling portion 204 in the predetermined number of the arithmetic blocks 201 (2), 201 (3) positioned in the vicinity of the arithmetic block 201 (4) is generated as the second data. The second data corresponds to the subtraction data G.

In the second arithmetic cycle by the arithmetic processing apparatus 200, the normalization execution portion 205f in the arithmetic block 201 (4) executes the normalization processing of the pooling data Pj based on the subtraction data G obtained from the subtractor 205g in the arithmetic block 201 (4) including the normalization execution portion 205f. Accordingly, the normalized processing data Nj (1,1) corresponding to the processing result data Pj (1,1) in the pooling processing is obtained.

In the second arithmetic cycle by the arithmetic processing apparatus 200, the adder 205b in the arithmetic block 201 (5) stores a data obtained by accumulating a value P5 (1,1)̂2 that is obtained by squaring a pooling data P5 (1,1) generated by the pooling portion 104 in the arithmetic block 201 (5) including the adder 205b, the value P2 (1,1)̂2, the value P3 (1,1)̂2, and the value P4 (1,1)̂2 obtained from another arithmetic blocks 201 (2) to 201 (4). The adder 205b in the arithmetic block 201 (5) stores a cumulative value of the value P2 (1,1)̂2, the value P3 (1,1)̂2, the value P4 (1,1)̂2, and the value P5 (1,1)̂2.

The FIFO memory 205h in the arithmetic block 201 (5) stores the value P2 (1,1)̂2 obtained from the arithmetic block 201 (2). The subtractor 205g in the arithmetic block 201 (5) outputs a value obtained by subtracting the value P2 (1,1)̂2 stored in the FIFO memory 205h from the cumulative value of the value P2 (1,1)̂2, the value P3 (1,1)̂2, the value P4 (1,1)̂2, and the value P5 (1,1)̂2 stored in the adder 205b. That is, the subtractor 205g outputs the cumulative value of the value P3 (1,1)̂2, the value P4 (1,1)̂2, and the value P5 (1,1)̂2. Accordingly, the addition data obtained by adding the square value P5 (1,1)̂2 of the processing result data generated by the pooling portion 204 in the arithmetic block 201 (5) including the subtractor 205g, the square values P3 (1,1)̂2 and P4 (1,1)̂2 of the processing result data generated by the pooling portions 204 in the predetermined number of the arithmetic blocks 201 (3), 201 (4) provided in the vicinity of the arithmetic block 201 (5) is generated as the second data. The second data corresponds to the subtraction data G.

In the third arithmetic cycle by the arithmetic processing apparatus 200, the normalization execution portion 205f in the arithmetic block 201 (5) executes the normalization processing of the pooling data Pj based on the subtraction data G obtained from the subtractor 205g in the arithmetic block 201 (5) including the normalization execution portion 205f. Accordingly, the normalized processing data Nj (1,1) corresponding to the processing result data Pj (1,1) in the pooling processing is obtained.

According to the arithmetic processing apparatus 200, it may be possible to normalize the pooling data Pj generated by the pooling portion 204 in the arithmetic block 201 (n) using the pooling data Pj generated by the pooling portion 204 in a different arithmetic block 201 (n). It may be possible to precisely normalize the pooling data Pj by the pooling processing, and to realize a more superior feature extraction processing. The normalization portion 205 includes the flip-flop circuit 205c functioning as the first output portion, the flip-flop circuit 205e functioning as the second output portion, the normalization execution portion 205f that normalizes the pooling data Pj obtained from the first output portion based on the subtraction data G obtained from the second output portion. Therefore, it may be possible to realize the normalization portion 205 and the arithmetic processing apparatus 200 without making a complex circuit configuration.

According to the arithmetic processing apparatus 200, the flip-flop circuit 205e functioning as the second output portion outputs the addition data obtained by adding the square value of the pooling data Pj by the pooling portion 204 in the arithmetic block 201 (n) including the flip-flop circuit 205e and the square value of the pooling data Pj generated by the pooling portion 204 in a predetermined number of the arithmetic blocks 201 (n−2), 201 (n−1) provided in the lower side vicinity of the arithmetic block 201 (n) including the flip-flop circuit 205e. The addition data corresponds to the subtraction data G and the second data. According to the second output portion, it may be possible to realize the normalization portion 205 and the arithmetic processing apparatus 200 with a more simple circuit configuration.

Incidentally, the predetermined number may be set appropriately with changing. It should be noted that the number of the arithmetic block 201 (n) in the arithmetic processing apparatus 200 is not limited to the number of the present embodiment, and the number of the arithmetic block 201 (n) may be determined appropriately with changing.

Incidentally, each of the arithmetic blocks 201 (1) to 201 (5) may correspond to a subject arithmetic block. The flip-flop circuit 205e in each of the arithmetic blocks 201 (1) to 201 (5) may correspond to a subject second output portion. The pooling portion 204 in each of the arithmetic blocks 201 (1) to 201 (5) may correspond to a subject pooling portion in the present disclosure.

### Third Embodiment

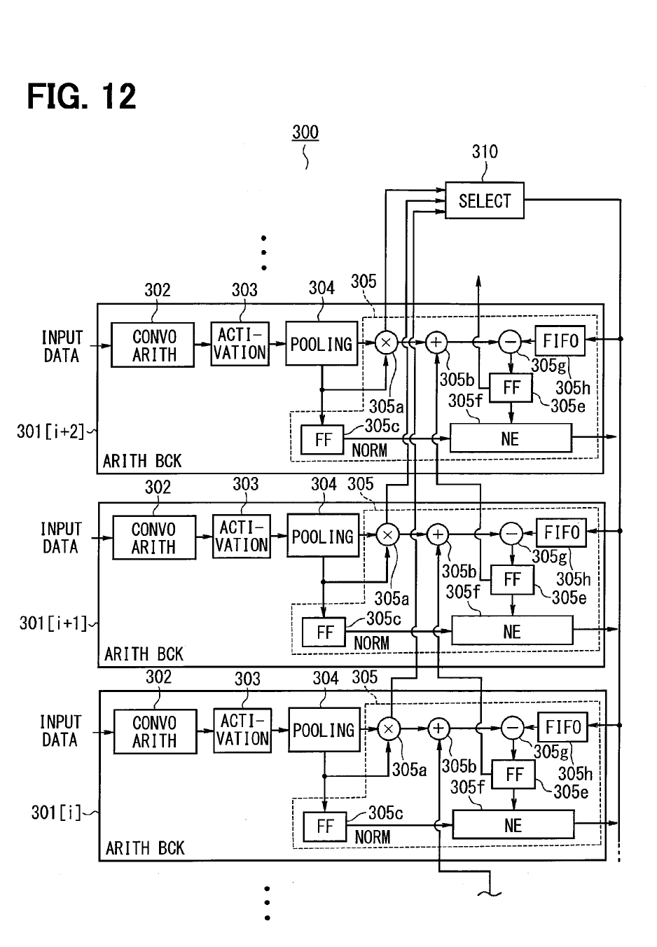

An arithmetic processing apparatus 300 described in FIG. 12 corresponds to a configuration including the configuration of the arithmetic processing apparatus 200 and in addition a selection circuit 310. The selection circuit 310 corresponds to an example of a selection portion. The selection circuit 310 selects one of the values Pĵ2 obtained by squaring the pooling data Pj generated by the pooling portion 304 in a predetermined number of the arithmetic blocks 301 (n). That is, the selection circuit 310 receives square values Pĵ2 of the pooling data Pj generated by the pooling portion 304 from a multiplier 305a of multiple arithmetic blocks 301 (n). The selection circuit 310 selects one of the multiple square values Pĵ2, which is input. The selection circuit 310 outputs the selected square value Pĵ2 to the FIFO memory 305h in each arithmetic block 301 (n).

In each arithmetic block 301 (n), a subtractor 305g subtracts the square value Pĵ2, which is output from the FIFO memory 305h, from the cumulative value output from an adder 305b. The square value Pĵ2 output from the FIFO memory 305h corresponds to the square value Pĵ2 that is selected by the selection circuit 310, so that the subtractor 305g generates a subtraction data G. A normalization execution portion 305f receives the subtraction data G as the second data. Incidentally, a selection condition when the selection circuit 310 selects the square value Pĵ2 may be configured appropriately with changing. That is, the selection circuit 310 may select, for example, a maximum value, a minimum value, an intermediate value, a value satisfying a predetermined condition among multiple input square values Pĵ2.

According to the arithmetic processing apparatus 300, it may be possible to normalize the pooling data Pj generated by the pooling portion 304 in the arithmetic block 301 (n) using the pooling data Pj generated by the pooling portion 304 in a different arithmetic block 301 (n). It may be possible to precisely normalize the pooling data Pj of the pooling processing, and to realize a more superior feature extraction processing. The normalization portion 305 includes a flip-flop circuit 305c functioning as the first output portion, a flip-flop circuit 305e functioning as the second output portion, the normalization execution portion 305f that normalizes the pooling data Pj obtained from the first output portion based on the subtraction data G obtained from the second output portion. Therefore, it may be possible to realize the normalization portion 305 and the arithmetic processing apparatus 300 without making a complex circuit configuration.

According to the arithmetic processing apparatus 300, the selection circuit 310 selects one of square values Pĵ2 of the pooling data Pj generated by the pooling portion 304 in a predetermined number of the arithmetic blocks 301 (n). The flip-flop circuit 305e functioning as the second output portion outputs the subtraction data G obtained by subtracting the square value Pĵ2 of the pooling data Pj selected by the selection circuit 310 from the cumulative value that the adder 305b outputs. The subtraction data G corresponds to the second data. Accordingly, it may be possible to realize the normalization portion 305 and the arithmetic processing apparatus 300 with a more simple circuit configuration.

Incidentally, the predetermined number may be set appropriately with changing. It should be noted that the number of the arithmetic block 301 (n) in the arithmetic processing apparatus 300 is not limited to the number of the present embodiment, and the number of the arithmetic block 301 (n) may be determined appropriately. The selection circuit 310 may be applied to the arithmetic processing apparatus 100.

### OTHER EMBODIMENTS

The present disclosure is not limited to the present embodiment. The present disclosure may be applicable to various modifications without deviating from the technical scope.

According to one aspect of the present disclosure, an arithmetic processing apparatus includes multiple arithmetic blocks. The arithmetic block includes a convolution arithmetic portion, an activation portion, a pooling portion, and a normalization portion. The convolution arithmetic portion executes convolution arithmetic processing to an input data that is input from a preceding layer. The activation portion executes activation processing to a processing result data generated by the convolution arithmetic portion. The pooling portion executes pooling processing to a processing result data generated by the activation portion. The normalization portion executes normalization processing to a processing result data generated by the pooling portion.

The normalization portion includes a first output portion, a second output portion, and a normalization execution portion. The first output portion outputs a processing result data generated by the pooling portion in the arithmetic block including the first output portion, as a first data. The second output portion outputs an addition data obtained by adding a processing result data generated by the pooling portion in the arithmetic block including the second output portion and a processing result data generated by the pooling portion in the different arithmetic block. The normalization execution portion executes normalization processing to the first data based on the second data.

According to the arithmetic processing apparatus, it may be possible to normalize the processing result data generated by the pooling portion in the arithmetic block using the processing result data generated by the pooling portion in a different arithmetic block. It may be possible to precisely normalize the processing result data generated by the pooling processing, and to realize a more superior feature extraction processing. The normalization portion includes the first output portion, the second output portion, and the normalization execution portion. Therefore, it may be possible to realize the normalization portion without making a complex circuit configuration.

In addition, according to the arithmetic processing apparatus, the second output portion may output an addition data as the second data. The addition data is obtained by adding a processing result data generated by each of the all pooling portion in the multiple arithmetic block including the arithmetic block with the second output portion.

In addition, according to the arithmetic processing apparatus, the second output portion may output the addition data as the second data. In this case, the addition data is obtained by adding the processing result data generated by the pooling portion in the arithmetic block including the second output portion and the processing result data generated by the pooling portion in a predetermined arithmetic blocks provided in the vicinity of the arithmetic block including the second output portion.

According to the arithmetic processing apparatus in the present disclosure, the arithmetic processing apparatus may include a selection circuit that selects one of the processing result data generated by the pooling portion in the predetermined number of the arithmetic blocks. The second output portion outputs the second data generated based on the processing result data that the selection portion has selected.

According to the arithmetic processing apparatus having the second output portion, it may be possible to realize the normalization portion with a more simple circuit configuration.

Incidentally, a convolution arithmetic portion may also be referred to as a convolution arithmetic processing portion, an activation portion may also be referred to as an activation processing portion, a pooling portion may also be referred to as a pooling processing portion, and a normalization execution portion may also be referred to as a normalization processing execution portion.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An arithmetic processing apparatus executing arithmetic by a neural network in which a plurality of processing layers are hierarchically connected, the arithmetic processing apparatus comprising
a plurality of arithmetic blocks corresponding to one of the plurality of processing layers, wherein
each of the plurality of arithmetic blocks includes:
a convolution arithmetic portion executing convolution arithmetic processing to an input data that is input from an other of the plurality of processing layers;
an activation portion executing activation processing to a processing result data generated by the convolution arithmetic portion;
a pooling portion executing pooling processing to a processing result data generated by the activation portion; and
a normalization portion executing normalization to a processing result data generated by the pooling portion, and
the normalization portion includes:
a first output portion outputting the processing result data generated by the pooling portion as a first data, wherein the normalization portion is included in a certain arithmetic block same as the pooling portion;
a second output portion outputting an addition data as a second data, wherein the addition data is obtained by adding
the first data, and
a processing result data generated by a pooling portion in a different arithmetic block, which is different from the certain arithmetic block generating the first data; and
a normalization execution portion executing normalization to the first data based on the second data.

2. The arithmetic processing apparatus according to claim 1, wherein
a subject arithmetic block of the plurality of arithmetic blocks includes a subject second output portion corresponding to the second output portion,
the subject second output portion outputs an other addition data as the second data,
the other addition data is obtained by adding a plurality of processing result data generated by pooling portions in the plurality of arithmetic blocks including the subject arithmetic block.

3. The arithmetic processing apparatus according to claim 1, wherein
a subject arithmetic block of the plurality of arithmetic blocks includes a subject second output portion corresponding to the second output portion and a subject pooling portion corresponding to the pooling portion,
the subject second output portion outputs an other addition data as the second data,
the other addition data is obtained by adding
a processing result data generated by the subject pooling portion in the subject arithmetic block and
a processing result data generated by pooling portions included in a predetermined number of arithmetic blocks, and
the predetermined number of arithmetic blocks are in a vicinity of the subject arithmetic block.

4. The arithmetic processing apparatus according to claim 1, further comprising
a selection portion selecting one of a plurality of processing result data generated by pooling portions in the plurality of arithmetic blocks, and
the second output portion outputs the second data, which is generated based on the one of the plurality of processing result data selected by the selection portion.
